(19) United States
(12) Patent Application Publication
(10) Pub. No.: US 2017/0118489 A1
(43) Pub. Date: Apr. 27, 2017

(54) High Dynamic Range Non-Constant Luminance Video Encoding and Decoding Method and Apparatus

(71) Applicant: Broadcom Corporation, Irvine, CA (US)

(72) Inventors: Gheorghe BERBECEL, Irvine, CA (US); Richard Hayden Wyman, Sunnyvale, CA (US)

(73) Assignee: Broadcom Corporation, Irvine, CA (US)

(21) Appl. No.: 14/930,120

(22) Filed: Nov. 2, 2015

Related U.S. Application Data
(60) Provisional application No. 62/245,368, filed on Oct. 23, 2015.

(51) Int. Cl. H04N 19/593; H04N 19/61; H04N 19/80; G06T 5/00; G09G 5/02

(52) U.S. Cl. CPC H04N 19/593; G06T 5/009; G09G 5/02; H04N 19/80; H04N 19/61; G06T 2207/10024; G06T 2207/20208; G06T 2207/20024; G09G 2360/16

(57) ABSTRACT

Compounding reproduction errors in the luminance of a pixel encoded by a non-constant luminance video encoder is High Dynamic Range (HDR) video content, which is starting to become more widely supported by commercially available display devices. HDR video content contains information that covers a wider luminance range than traditional, non-HDR video content known as Low Dynamic Range (LDR) video content. The present disclosure is directed to an apparatus and method for reducing errors in reproduced luminance of HDR video content (and other types of video content) at a video encoder and/or video decoder due to non-constant luminance video encoding.

### CROSS REFERENCE TO RELATED APPLICATIONS

This application claims the benefit of U.S. Provisional Patent Application No. 62/245,368, filed Oct. 23, 2015, which is incorporated by reference herein in its entirety.

### TECHNICAL FIELD

This application relates generally to video encoding and decoding, including high dynamic range (HDR) non-constant luminance video encoding and decoding.

### BACKGROUND

Each pixel of a color image is typically sensed and displayed as three color components, such as red (R), green (G), and blue (B). However, in between the time in which the color components of a pixel are sensed and the time in which the color components of a pixel are displayed, a video encoder is often used to transform the color components into another set of components to provide for more efficient storage and/or transmission of the pixel data.

More specifically, the human visual system has less sensitivity to variations in color than to variations in brightness (or luminance). Digital video encoders are designed to exploit this fact by transforming the R, G, and B components of a pixel into a luminance component (Y) that represents the brightness of the pixel and two color difference (chroma) components (C_{B} and C_{R}) that respectively represent the B and R components of the pixel separate from the brightness. Once the R, G, and B components of a color image's pixels are transformed into Y, C_{B}, and C_{R} components, the C_{B} and C_{R} components of the color image's pixels can be subsampled (relative to the luminance component Y) to reduce the amount of space required to store the color image and/or the amount of bandwidth needed to transmit the color image to another device. Assuming the C_{B} and C_{R} components are properly subsampled, the quality of the image as perceived by the human eye should not be affected to a large or even noticeable degree because of the human visual system's lesser sensitivity to variations in color.

In addition to subsampling of the chroma components, digital video encoders typically use perceptual quantization to further reduce the amount of space required to store a color image and/or the amount of bandwidth required to transmit the color image to another device. More specifically, the human visual system has been further shown to be more sensitive to differences in smaller luminance values (or darker values) than differences in larger luminance values (or brighter values). Thus, rather than quantizing or coding luminance linearly with a larger number of bits, a smaller number of bits with fewer code values assigned nonlinearly on a perceptual scale can be used. Ideally, the code values should be assigned such that each step between adjacent code values corresponds to a just noticeable difference in luminance. To this end, perceptual transfer functions have been defined to provide for such perceptual quantization of the luminance Y of a pixel. The perceptual transfer functions are generally power functions, such as the perceptual transfer function defined by The Society of Motion Picture and Television Engineers (SMPTE) and referred to as the SMPTE ST-2084.

### BRIEF DESCRIPTION OF THE DRAWINGS/FIGURES

The accompanying drawings, which are incorporated herein and form a part of the specification, illustrate the present disclosure and, together with the description, further serve to explain the principles of the disclosure and to enable a person skilled in the pertinent art to make and use the disclosure.

FIG. 1 illustrates a constant luminance video encoder that implements both chroma subsampling and perceptual quantization and a corresponding video decoder in accordance with embodiments of the present disclosure.

FIG. 2 illustrates a non-constant luminance video encoder that implements both chroma subsampling and perceptual quantization and a corresponding video decoder in accordance with embodiments of the present disclosure.

FIG. 3 illustrates two pixels and their respective color components as plotted on a color gamut in accordance with embodiments of the present disclosure.

FIG. 4 illustrates a plot of an example perceptual quantization function in accordance with embodiments of the present disclosure.

FIG. 5 illustrates a color gamut in accordance with embodiments of the present disclosure

FIG. 6 illustrates a non-constant luminance video encoder in accordance with embodiments of the present disclosure.

FIG. 7 illustrates a flowchart of a method for non-constant luminance video encoding in accordance with embodiments of the present disclosure.

FIG. 8 illustrates a non-constant luminance video decoder in accordance with embodiments of the present disclosure

FIG. 9 illustrates a flowchart of a method for non-constant luminance video decoding in accordance with embodiments of the present disclosure.

FIG. 10 illustrates a block diagram of an example computer system that can be used to implement aspects of the present disclosure.

The present disclosure will be described with reference to the accompanying drawings. The drawing in which an element first appears is typically indicated by the leftmost digit(s) in the corresponding reference number.

### DETAILED DESCRIPTION

In the following description, numerous specific details are set forth in order to provide a thorough understanding of the disclosure. However, it will be apparent to those skilled in the art that the disclosure, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring aspects of the disclosure.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

For purposes of this discussion, the term “module” shall be understood to include software, firmware, or hardware (such as one or more circuits, microchips, processors, and/or devices), or any combination thereof. In addition, it will be understood that each module can include one, or more than one, component within an actual device, and each component that forms a part of the described module can function either cooperatively or independently of any other component forming a part of the module. Conversely, multiple modules described herein can represent a single component within an actual device. Further, components within a module can be in a single device or distributed among multiple devices in a wired or wireless manner.

### 1. NON-CONSTANT LUMINANCE VS. CONSTANT LUMINANCE

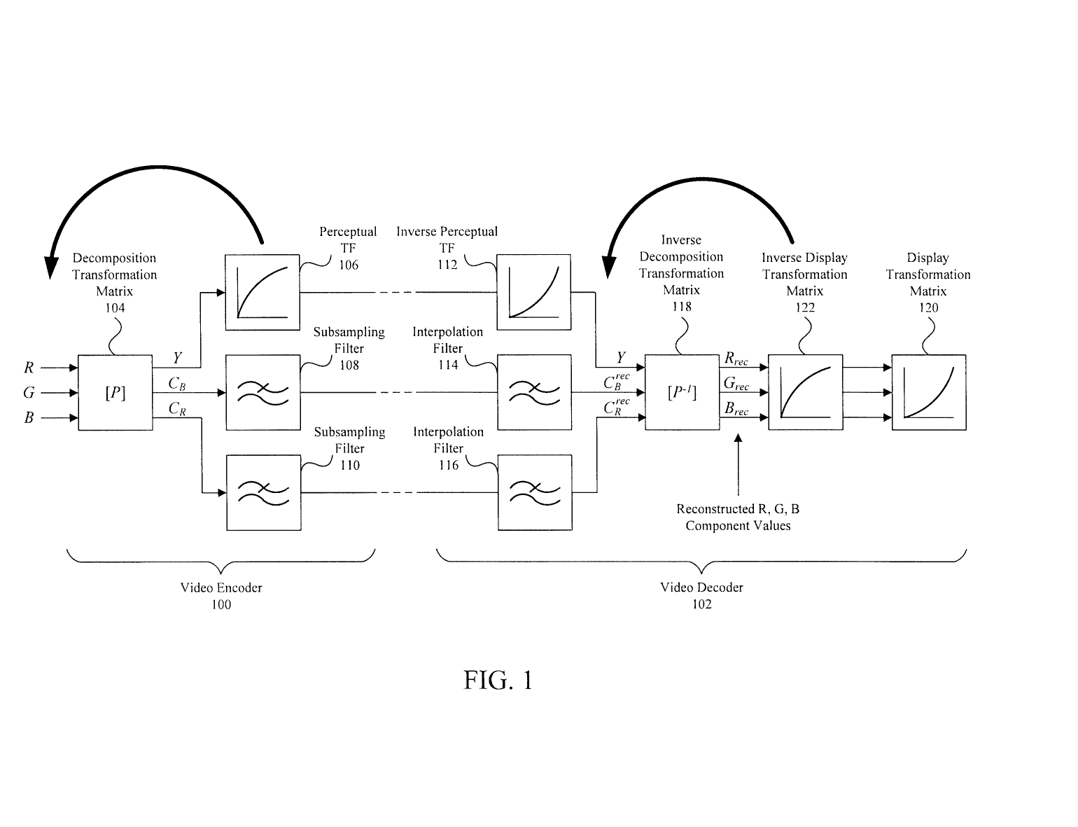

Before describing specific embodiments of the present disclosure, it is instructive to first consider the difference between non-constant and constant luminance video encoding. To this end, FIG. 1 illustrates a video encoder 100, which implements both chroma subsampling and perceptual quantization as explained above, and a corresponding video decoder 102. Video encoder 100 and video decoder 102 are provided by way of example and are not meant to be limiting.

As illustrated in FIG. 1, video encoder 100 receives R, G, and B components of a pixel as input and transforms the three color components into a luminance component Y and two color difference (chroma) components C_{B} and C_{R} using a 3×3 decomposition transformation matrix 104. Decomposition transformation matrix 104 can be defined, for example, based on the ITU-R Recommendation BT.709 (also known as Rec.709) and can be written out as the following set of three equations:

Y=0.2126*R+0.7152*G+0.0722*B (1)

C_{B}=0.5389*(B−Y) (2)

C_{R}=0.6350*(R−Y) (3)

It should be noted that the three equations represent only one possible implementation of decomposition transformation matrix 104 in FIG. 1. Other implementations of decomposition transformation matrix 104 in FIG. 1 can be used as would be appreciated by one of ordinary skill in the art. For example, decomposition transformation matrix 104 in FIG. 1 can be defined based on the ITU-R Recommendation BT.2020.

After the luminance component Y and two chroma components C_{B} and C_{R} are obtained, the luminance component Y undergoes perceptual quantization by perceptual transfer function 106 and the two chroma components C_{B} and C_{R} are respectively subsampled by subsampling filters 108 and 110. In general, subsampling filters 108 and 110 may respectively filter a group of C_{B} components and a group of C_{R} components that correspond to a rectangular region of pixels and then discard one or more of the C_{B} and C_{R} chroma components from their respective groups. The filtering can be implemented as a weighted average calculation, for example. Subsampling filters 108 and 110 pass the filtered and/or remaining C_{B} and C_{R} chroma component(s) to the decoder. Subsampling filters can implement one of the common 4:2:2 or 4:2:0 subsampling schemes, for example.

Video decoder 102 receives the perceptually quantized luminance component PQ(Y), where PQ( ) represents perceptual transfer function 106, and transforms the perceptually quantized luminance component PQ(Y) back into the luminance component Y using an inverse perceptual transfer function 112. Inverse perceptual transfer function 112 can implement a power function with an exponent equal (or approximately equal) to the reciprocal of the exponent of the power function of perceptual transfer function 106. Video decoder 102 further receives the subsampled chroma components and uses interpolation filters 114 and 116 to respectively recover (e.g., via interpolation), as best as possible or at least to some degree, the samples of chroma components C_{B} and C_{R} that were discarded by subsampling filters 108 and 110 at video encoder 100. The luminance component Y and the recovered chroma components C_{B}^{rec} and C_{R}^{rec} then transformed back into color components R_{rec}, G_{rec}, and B_{rec} using an inverse decomposition transformation matrix 118 that implements the inverse 3×3 matrix of decomposition transformation matrix 104.

One issue with old CRT displays and with other, more modern, display technologies is that the displays introduce their own power function. This power function is represented by display transformation matrix 120 in FIG. 1. Video decoder 102 compensates for the display's power function using an inverse display transformation matrix 122 with an exponent equal (or approximately equal) to the reciprocal of the exponent of the power function of the display. Thus, video decoder 102 implements two non-linear transfer functions: inverse perceptual transfer function 112 and inverse display transfer function 122.

At least historically, to avoid having to implement two such non-linear transfer functions, a simplification to video decoder 102 was often realized. In particular, the power functions implemented by inverse perceptual transfer function 112 and inverse display transformation matrix 122 were typically very close to being inverses of each other. As a result, by moving inverse display transformation matrix 122 in front of inverse decomposition transformation matrix 118 (as indicated by the right-most dark arrow in FIG. 1), the two non-linear transfer functions would be positioned next to each other and have no net effect (or at least a smaller net effect). Thus, inverse perceptual transfer function 112 and inverse display transformation matrix 122 could be removed from video decoder 102. However, the repositioning of inverse display transformation matrix 122 would require video encoder 100 to be rearranged to mirror the changes made to video decoder 102. In particular, perceptual transfer function 106 would be moved in front of decomposition transformation matrix 104 (as indicated by the left-most dark arrow in FIG. 1) to mirror the changes made to video decoder 102.

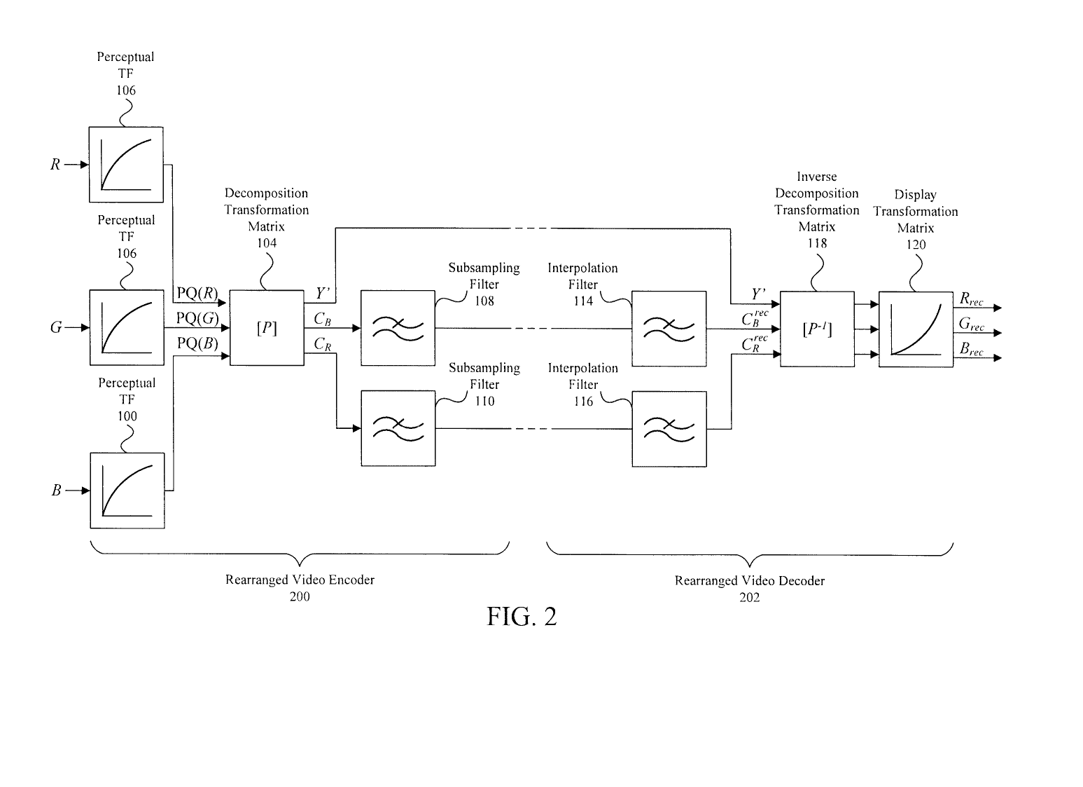

FIG. 2 illustrates the rearranged video encoder 200 and rearranged video decoder 202. Although the rearrangement allowed video decoder 102 to be simplified, the rearrangement is not entirely equivalent to video encoder 100 and video decoder 102 as shown in FIG. 1. In particular, decomposition transformation matrix 104 no longer operates on linear color components R, G, and B but non-linear color components PQ(R), PQ(G), and PQ(B), where PQ( ) again represents perceptual transfer function 106. Consequently, luminance Y is now computed by a non-linear approximation to luminance called luma Y′. In addition, the two chroma components C_{B} and C_{R} are further computed by non-linear approximations. Decomposition transformation matrix 104 in FIG. 2 can now be written out as the following set of three equations as defined by the ITU-R Recommendation BT.709:

Y′=0.2126*PQ(R)+0.7152*PQ(G)+0.0722*PQ(B) (4)

C_{B}=0.5389*(PQ(B)−Y′) (5)

C_{R}=0.6350*(PQ(R)−Y′) (6)

It should again be noted that the three equations represent only one possible implementation of decomposition transformation matrix 104 in FIG. 2. Other implementations of decomposition transformation matrix 104 in FIG. 2 can be used as would be appreciated by one of ordinary skill in the art. For example, decomposition transformation matrix 104 in FIG. 2 can be defined based on the ITU-R Recommendation BT.2020. It should be further noted that video decoder 202 in FIG. 2 can still implement an inverse perceptual transfer function after inverse decomposition transformation matrix 118 and/or an inverse display transformation matrix after inverse decomposition transformation matrix 118.

The implication of the changes to the rearranged video encoder 200 in FIG. 2 is that the rearranged video encoder 200 no longer adheres to the principle of “constant luminance.” In a constant luminance video encoder, a single component is formed from which the luminance information of a pixel can be reconstructed at the video decoder. Prior to the rearrangement of video encoder 100, the luminance information of a pixel was exclusively carried by the luminance Y. As a result, assuming the luminance Y was received by video decoder 102 without errors, the luminance information of the pixel could be recovered in its entirety.

In the rearranged video encoder 200 in FIG. 2, the luma Y′ carries the majority of the luminance information of a pixel in most instances but not all of the luminance information. Specifically, it can be shown that some of the luminance information is now carried by the two chroma components C_{B} and C_{R} in the rearranged video encoder 200. Thus, the rearranged video encoder 200 is referred to as a “non-constant luminance” video encoder. To recover the luminance information of a pixel, without errors, rearranged video decoder 202 in FIG. 2 must not only recover the luma Y′, but also the two chroma components C_{B} and C_{R}. This generally would not be a problem, but the two chroma components C_{B} and C_{R} are specifically created to be subsampled. Thus, the luminance of a pixel is often incorrectly recovered, at least to some degree, at video decoder 202.

Compounding reproduction errors in the luminance of a pixel encoded by a non-constant luminance video encoder is High Dynamic Range (HDR) video content, which is starting to become more widely supported by commercially available display devices. HDR video content contains information that covers a wider luminance range (e.g., the full luminance range visible to the human eye or a dynamic range on the order of 100,000:1) than traditional, non-HDR video content known as Standard Dynamic Range (SDR) video content. As will be explained further below, the present disclosure is directed to an apparatus and method for reducing errors in reproduced luminance of HDR video content (and other types of video content) at a video decoder and/or encoder due to non-constant luminance video encoding.

It should be noted that, in FIG. 1, the R and B color components received by encoder 100 are typically also perceptually quantized prior to being used by decomposition transformation matrix 104 to calculate chroma components C_{B} and C_{R}. In such an implementation, perceptual quantized luma component Y′ would further be used in such calculations of the chroma components C_{B} and C_{R}.

### 2. ERRORS RESULTING FROM HDR NON-CONSTANT LUMINANCE VIDEO ENCODING

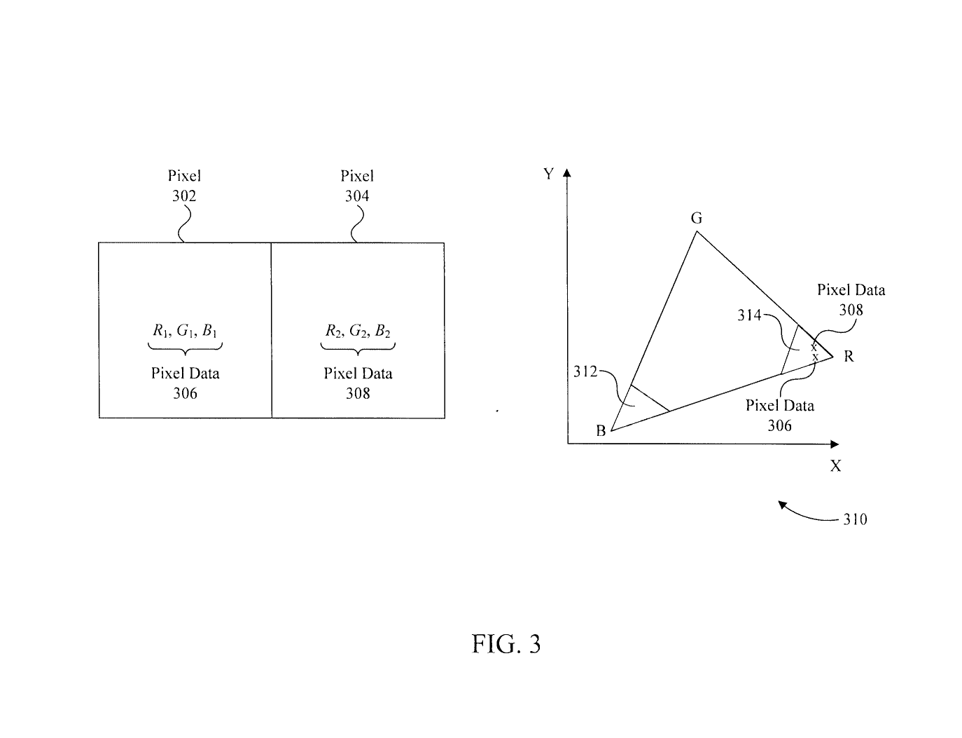

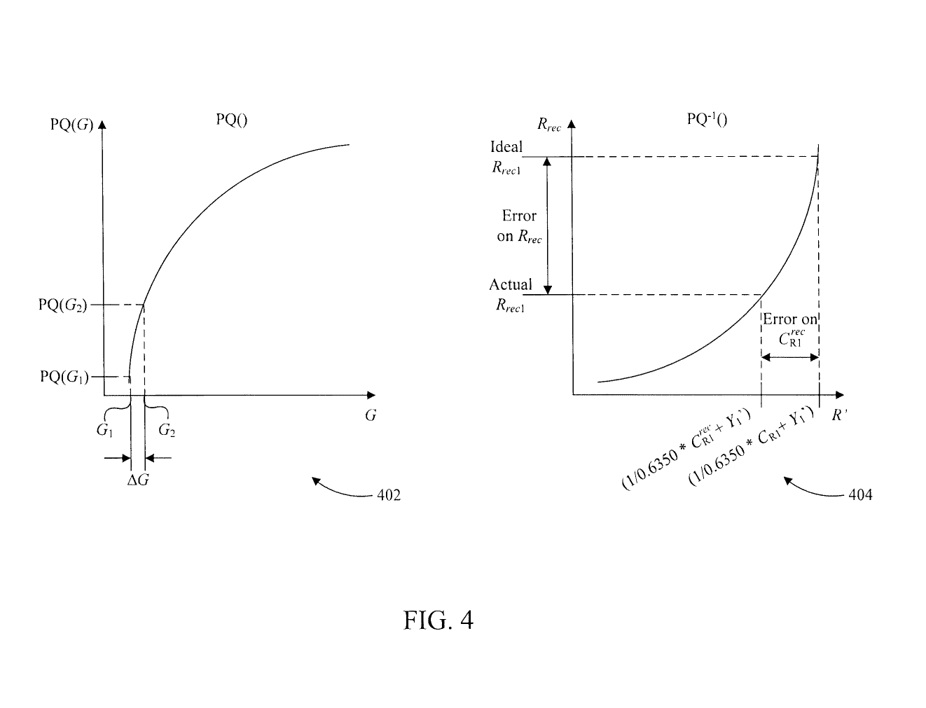

To provide further context as to the errors in reproduced luminance that the apparatus and method of the present disclosure are directed to reducing, an example of a simplified non-constant luminance video encoding and decoding operation is provided with respect to FIGS. 3 and 4.

Referring now to FIG. 3, two pixels 302 and 304 are shown. Pixel 302 and pixel 304 are adjacent to each other in a color image and are respectively defined by pixel data 306 and pixel data 308. Pixel data 306 includes three color components R₁, G₁, and B₁ that respectively represent the amount of red, green, and blue that make up the color of pixel 302. Pixel data 308 includes three color components R₂, G₂, and B₂ that respectively represent the amount of red, green, and blue that make up the color of pixel 304.

The above mentioned errors in luminance reproduced at a video decoder generally occur when pixels located near each other in a color image, such as pixels 302 and 304, both have either large red color component values or large blue color component values and both have small green color components. HDR video systems make such errors more possible because they generally provide for larger and smaller possible color component values of a pixel than LDR video systems. In other words, the color gamut of an HDR video system is generally wider.

FIG. 3 illustrates an example color gamut 310 for an HDR video system with two highlighted areas 312 (near the blue vertex) and 314 (near the red vertex). When the respective colors of the two closely located pixels both have large blue values and small green values, the two pixels have colors located in area 312 and there is a potential for a large error in the reproduced luminance for at least one of the pixels. When the respective colors of the two closely located pixels both have large red values and small green values, the two pixels have colors located in area 314 and there is a potential for a large error in the reproduced luminance for at least one of the pixels.

For example, assume that the respective colors of pixels 302 and 304 are both within area 314, as shown in color gamut 310 by the two points or x's, and have the same large value of red (i.e., R₁=R₂), the same value of blue (i.e., B₁=B₂), and have small values of green that differ by at least some amount (i.e., G₂=G₁+ΔG). Despite having nearly identical colors and therefore nearly identical values of luminance as given by Eq. (1), the small difference between the small green component values of pixels 302 and 304 causes a large difference in their respective luma values, Y₁′ and Y₂′, as given by Eq. (4).

More specifically, from Eq. (4) above, the two luma values Y₁′ and Y₂′ can be written out as follows:

Y₁′=0.2126*PQ(R₁)+0.7152*PQ(G₁)+0.0722*PQ(B₁) (7)

Y₂′=0.2126*PQ(R₂)+0.7152*PQ(G₂)+0.0722*PQ(B₂) (8)

As can be seen, the components of luma values Y₁′ and Y₂′ that are dependent on red and blue will be identical because R₁=R₂ and B₁=B₂ as assumed above. The respective components of luma values Y₁′ and Y₂′ that are dependent on green, however, will vary by a large amount because of the small difference in G₁ and G₂ and the typically large slope of the perceptual quantization function PQ( ) for small input values.

For example, FIG. 4 illustrates a plot 402 of an example perceptual quantization function PQ( ). As can be seen from FIG. 4, the slope of plot 402 is large at the lower range of input values. As a result, for the small values of G₁ and G₂ and the small difference ΔG between them, a comparatively large difference results between the perceptually quantized values of PQ(G₁) and PQ(G₂). In turn, the large difference between PQ(G₁) and PQ(G₂) causes luma values Y₁′ and Y₂′ to vary by a large amount.

Taking the above example further, the large difference between luma values Y₁′ and Y₂′ further results in a large difference between the respective red chroma components, C_{R1} and C_{R2}, of pixels 302 and 304, which can be written out, based on Eq. (6) above, as follows:

C_{R1}=0.6350*(PQ(R₁)−Y₁′) (9)

C_{R2}=0.6350*(PQ(R₂)−Y₂′) (10)

Because of the methods in which the red chroma components are often subsampled by subsampling filter 110 in FIG. 2, the large difference between the respective red chroma components C_{R1} and C_{R2} of pixels 302 and 304, which represents high frequency spatial content, is often filtered out. For example, where subsampling filter 110 calculates a weighted average of the respective red chroma components C_{R1} and C_{R2} of pixels 302 and 304, and (potentially) the red chroma components of other pixels in a surrounding neighborhood of pixels 302 and 304, the large difference between the respective red chroma components C_{R1} and C_{R2} of pixels 302 and 304 can be filtered out.

In one instance, for example, the weighted average calculated by subsampling filter 110 can lean toward the red chroma component C_{R2} of pixel 304. After calculating the weighted average, subsampling filter 100 can pass the weighted average onto video decoder 102 in FIG. 2, while discarding the red chroma components of the pixels in the neighborhood of pixels 302 and 304 used to calculate the weighted average (including the respective red chroma components C_{R1} and C_{R2} of pixels 302 and 304). Interpolation filter 116 in FIG. 2 can use interpolation to recover the respective red chroma components C_{R1} and C_{R2} of pixels 302 and 304 that were discarded by subsampling filter 110. However, because of the spatial, low-pass filtering effect of subsampling filter 110 and the imperfect nature of interpolation, the respective red chroma components C_{R1} and C_{R2} of pixels 302 and 304 are generally recovered with errors. In the example instance given above, the red chroma component C_{R1}, in particular, can be recovered with a large error, although even a small error can be problematic.

It should be noted that subsampling filters 108 and 110, in general, are spatial low-pass filters. For example, in the case where subsampling filter 108 implements a weighted average of red chroma components of a group of pixels within a common neighborhood (e.g., pixels within a 4×1 or 4×2 rectangular region), the weighted average is a form of spatial low-pass filtering as would be appreciated by one of ordinary skill in the art.

Referring back to FIG. 2, after the chroma components are recovered at a video decoder by, for example, an interpolation filter, the recovered chroma components C_{B}^{rec} and C_{R}^{rec} and the luma component Y′ undergo inverse decomposition transformation matrix processing and inverse perceptual quantization processing PQ⁻¹( ) (e.g., via a display transformation matrix or some other transformation matrix). These two processing steps result in the recovered R_{rec}, B_{rec}, and G_{rec} component values and can be written out mathematically as follows based on the ITU-R Recommendation BT.709:

R_{rec}=PQ⁻¹(1/0.6350*C_{R}^{rec}+Y′) (11)

B_{rec}=PQ⁻¹(1/0.5389*C_{B}^{rec}+Y′) (12)

G_{rec}=PQ⁻¹(1/0.7152*(Y′−0.2126*PQ(R_{rec})−0.0722*PQ(B_{rec}))) (13)

Because of the error in the recovered red chroma component C_{R1}^{rec}, as explained above, the recovered red color component R_{recI} of pixel 302 will have an error. In fact, the error in the recovered red chroma component C_{R1}^{rec}, may be further amplified due to the large potential gain of inverse perceptual quantization function PQ⁻¹( ) used in the calculation of the recovered red color component R_{recI}. The gain of inverse perceptual quantization function PQ⁻¹( ) is typically larger for large encoded red component values, like those of pixels 302 and 304 in the example above.

For example, FIG. 4 further illustrates a plot 404 of an example inverse perceptual quantization function PQ⁻¹( ). As can be seen from FIG. 4, the slope of plot 404 is larger at the higher range of input values. As a result, the error in the recovered red chroma component C_{R1}^{rec} may be further amplified in the recovered red color component R_{recI}. This is shown in plot 404, which shows the ideal and actual recovered red color components R_{recI} of pixel 302. The ideal and actual recovered red color components R_{recI} of pixel 302 can be written out based on Eq. (11) above as follows:

Actual R_{recI}=PQ⁻¹(1/0.6350*C_{R1}^{rec}+Y₁′) (14)

Ideal R_{recI}=PQ⁻¹(1/0.6350*C_{R1}^{rec}+Y₁′) (15)

Visually, errors of this type can result in “dots” being displayed that are objectionable to viewers.

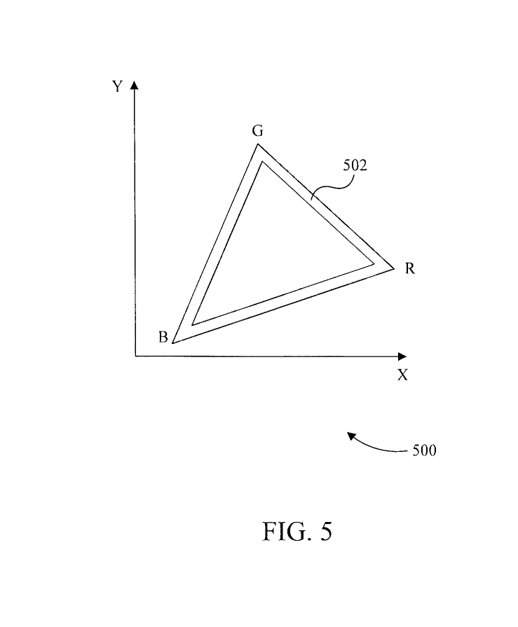

The above description provided one example when the color values of two closely located pixels in a color image may result in a large error in luminance reproduced at a video decoder for one or more of the two pixels. In general, when the color values of two closely located pixels in a color image are within either area 312 (i.e., have large blue components and small green components) or area 314 (i.e., have large red components and small green components), there is a potential for a large error in the luminance reproduced at a video decoder for at least one of the pixels similar to the error described above. Because of the larger values of the color components possible for HDR video content, this content is more prone to these large errors in luminance reproduced at a video decoder. Even more generally, when the color values of two closely located pixels in a color image are within a border region of a color gamut of a video system, such as border region 502 of color gamut 500 in FIG. 5, there is a potential for a large error in the luminance reproduced at a video decoder for at least one of the pixels similar to the error described above. It should be noted that the boundaries that determine areas 312 and 314 in FIG. 3 and border region 502 in FIG. 5 can be set based on a number of different factors, including based on experimental results, and are not necessarily defined by straight lines as shown in FIG. 3 and FIG. 5.

### 3. HDR NON-CONSTANT LUMINANCE VIDEO ENCODING FOR REDUCED ERRORS

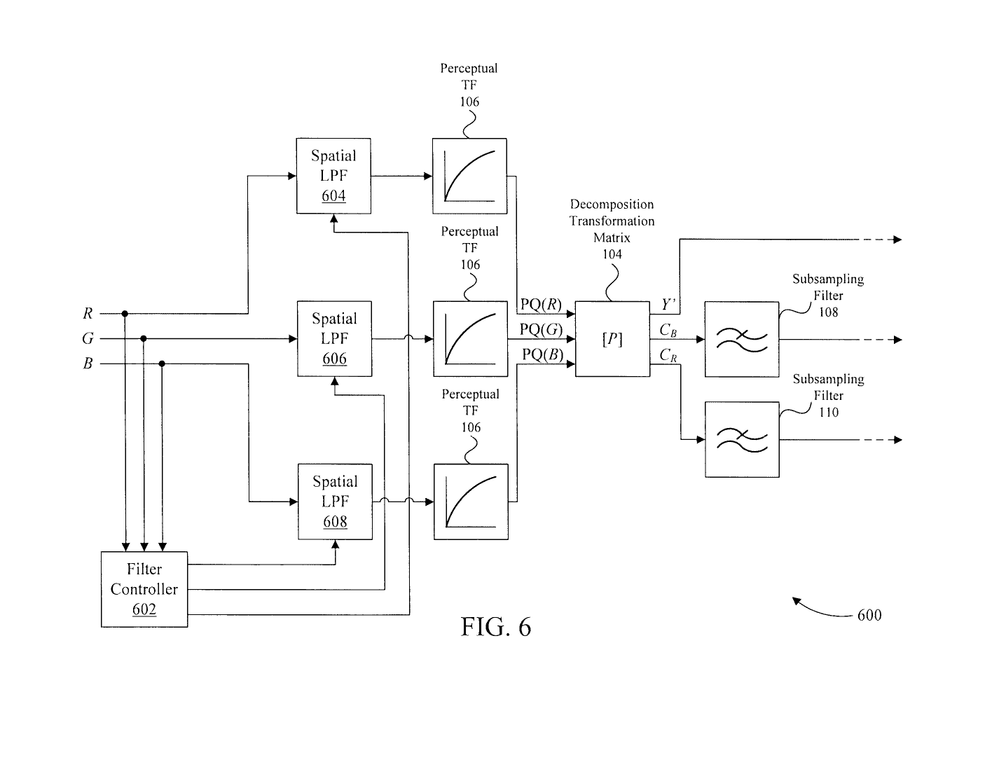

Referring now to FIG. 6, a non-constant luminance video encoder 600 for reducing errors in reproduced luminance of HDR video content (and other types of video content) at a video decoder due to non-constant luminance video encoding is illustrated in accordance with embodiments of the present disclosure. As can be seen, non-constant luminance video encoder 600 has the same exemplary configuration as non-constant luminance video encoder 200 in FIG. 2 with the exception of newly added filter controller 602 and spatial low-pass filters 604, 606, and 608.

Filter controller 602 is configured to determine if the color of a pixel being processed by video encoder 600 falls within a region of a color gamut that may result in a large error in the reproduced luminance of the pixel at a video decoder due to non-constant luminance encoding. For example, filter controller 602 can determine if the color of a pixel being processed by video encoder 600 falls with either region 312 or 314 of color gamut 310 in FIG. 3 or within border region 502 of color gamut 500 in FIG. 5. As shown in FIG. 6, filter controller 602 can make such a determination based on the R, G, and B color components of a pixel being processed by video encoder 600. It should be noted that other tri-stimulus color components, other than R, G, and B, can be processed by filter controller 602 and, more generally, by video encoder 600 as would be appreciated by one of ordinary skill in the art.

In one embodiment, filter controller 602 determines if the color of a pixel being processed by video encoder 600 falls with region 312 or 314 of color gamut 310 in FIG. 3 using threshold values. For example, filter controller 602 can determine the color of a pixel being processed by video encoder 600 falls within region 312 if the green color component G of the pixel is below a first threshold and the blue color component B of the pixel is above a second threshold. Similarly, filter controller 602 can determine the color of a pixel being processed by video encoder 600 falls within region 314 if the green color component G of the pixel is below a first threshold and the red color component R of the pixel is above a second threshold.

In another embodiment, filter controller 602 determines if the color of a pixel being processed by video encoder 600 falls with region 312 if the ratio of the blue color component B of the pixel to the green color component G of the pixel is above a threshold. Similarly, filter controller 602 determines if the color of a pixel being processed by video encoder 600 falls with region 314 if the ratio of the red color component R of the pixel to the green color component G of the pixel is above a threshold.

Upon determining that the color of a pixel being processed by video encoder 600 falls within region 312 or region 314, filter controller 602 can activate spatial low-pass filter 606 to spatially low-pass filter the green color component of the pixel being processed. Spatial low-pass filter 606 is configured to spatially smooth the green component of the pixel being processed by, for example, replacing the green component of the pixel with a weighted average of the green component of the pixel and the green components of pixels in a surrounding neighborhood of the pixel being processed. The neighborhood can be formed by a rectangular region of pixels, such as a 4×1 or a 4×2 region of pixels. The weights (or distribution of the weights) used to perform the weighted average by spatial low-pass filter 606 can be adjusted by filter controller 602 to increase or decrease the amount of spatial smoothing of the green component of the pixel being processed. For example, for larger ratios of the blue color component B of the pixel to the green color component G of the pixel, filter controller 602 can adjust the weights used by spatial low-pass filter 606 to increase the amount of spatial smoothing of the green component of the pixel.

By spatially smoothing the green component of the pixel being processed, the difference in the green component value of the pixel being processed as compared to the green components of the pixels in its neighborhood is reduced, which, in turn, should help to reduce the extent of any error of the type described above being produced.

With regard to spatial low-pass filter 604, filter controller 602 can control spatial low-pass filter 604 in a similar manner as spatial low-pass filter 606. In one embodiment, filter controller 602 can control spatial low-pass filter 604 to spatially low-pass filter the red color component R of the pixel being processed if the red color component R of the pixel is below a first threshold and the blue color component B of the pixel is above a second threshold. Similarly, filter controller 602 can control spatial low-pass filter 604 to spatially low-pass filter the red color component R of the pixel being processed if the red color component R of the pixel is below a first threshold and the green color component G of the pixel is above a second threshold.

In another embodiment, filter controller 602 can control spatial low-pass filter 604 to spatially low-pass filter the red color component R of the pixel being processed if the ratio of the blue color component B of the pixel to the red color component R of the pixel is above a threshold. Similarly, filter controller 602 can control spatial low-pass filter 604 to spatially low-pass filter the red color component R of the pixel being processed if the ratio of the green color component G of the pixel to the red color component R of the pixel is above a threshold.

With regard to spatial low-pass filter 608, filter controller 602 can control spatial low-pass filter 608 in a similar manner as spatial low-pass filter 606. In one embodiment, filter controller 602 can control spatial low-pass filter 608 to spatially low-pass filter the blue color component B of the pixel being processed if the blue color component B of the pixel is below a first threshold and the red color component R of the pixel is above a second threshold. Similarly, filter controller 602 can control spatial low-pass filter 608 to spatially low-pass filter the red color component B of the pixel being processed if the blue color component B of the pixel is below a first threshold and the green color component G of the pixel is above a second threshold.

In another embodiment, filter controller 602 can control spatial low-pass filter 608 to spatially low-pass filter the blue color component B of the pixel being processed if the ratio of the red color component R of the pixel to the blue color component B of the pixel is above a threshold. Similarly, filter controller 602 can control spatial low-pass filter 608 to spatially low-pass filter the blue color component B of the pixel being processed if the ratio of the green color component G of the pixel to the blue color component B of the pixel is above a threshold.

It should be noted that, in some embodiments, only one or two of spatial low-pass filters 604, 606, and 608 are used in video encoder 600. For example, in one embodiment, only spatial low-pass filter 606 is used and spatial low-pass filters 604 and 608 are omitted. It should be further noted that video encoder 600 can be implemented in any number of devices, including video recording devices, such as video cameras and smart phones with video recording capabilities.

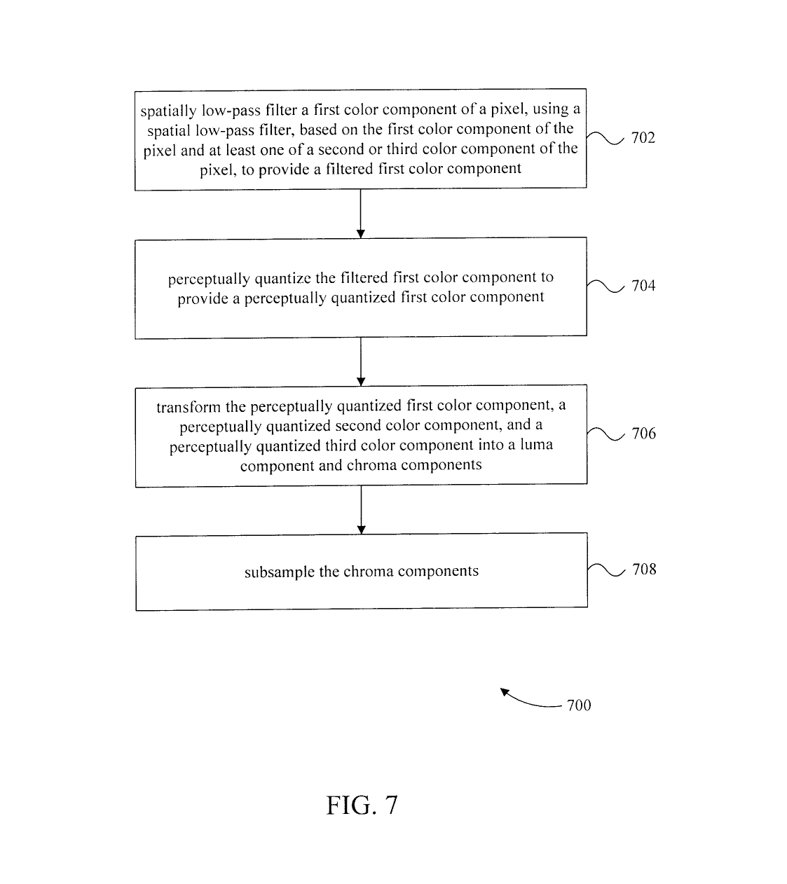

Referring now to FIG. 7, a flowchart 700 of a method for non-constant luminance video encoding of a pixel is illustrated in accordance with embodiments of the present disclosure. The method of flowchart 700 can be performed by video encoder 600 in FIG. 6 or some other video encoder.

The method of flowchart 700 begins at step 702. At step 702, a first color component of a pixel being encoded is spatially low-pass filtered based on the first color component of the pixel and at least one of a second or third color component of the pixel to provide a filtered first color component. For example, the first color component can be a green color component, the second color component can be a red color component, and the third color component can be a blue color component. The green color component can be spatially filtered if the color of the pixel falls within a region of a color gamut that may result in a large error in the reproduced luminance of the pixel at a video decoder due to non-constant luminance encoding. For example, if the color of the pixel being processed by video encoder 600 falls with either region 312 or 314 of color gamut 310 in FIG. 3 or within border region 502 of color gamut 500 in FIG. 5, the green color component can be spatially filtered. Threshold values, as described above in regard to FIG. 6 can be used to make such a determination.

After step 702, the method of flowchart 700 proceeds to step 704. At step 704, the filtered first color component can be perceptually quantized. For example, the filtered first color component can be perceptually quantized using one of perceptual transfer function 106 in FIG. 6.

After step 704, the method of flowchart 700 proceeds to step 706. At step 706, the perceptually quantized first color component together with a perceptually quantized second and third color component can be transformed into a luma component and chroma components. For example, decomposition transformation matrix 104 in FIG. 6 can be used to perform such a transformation.

After step 706, the method of flowchart 700 proceeds to step 708. At step 708, the chroma components can be subsampled. For example, the chroma components can be subsampled using subsampling filters 108 and 110 in FIG. 6.

### 4. HDR NON-CONSTANT LUMINANCE VIDEO DECODING FOR REDUCED ERRORS

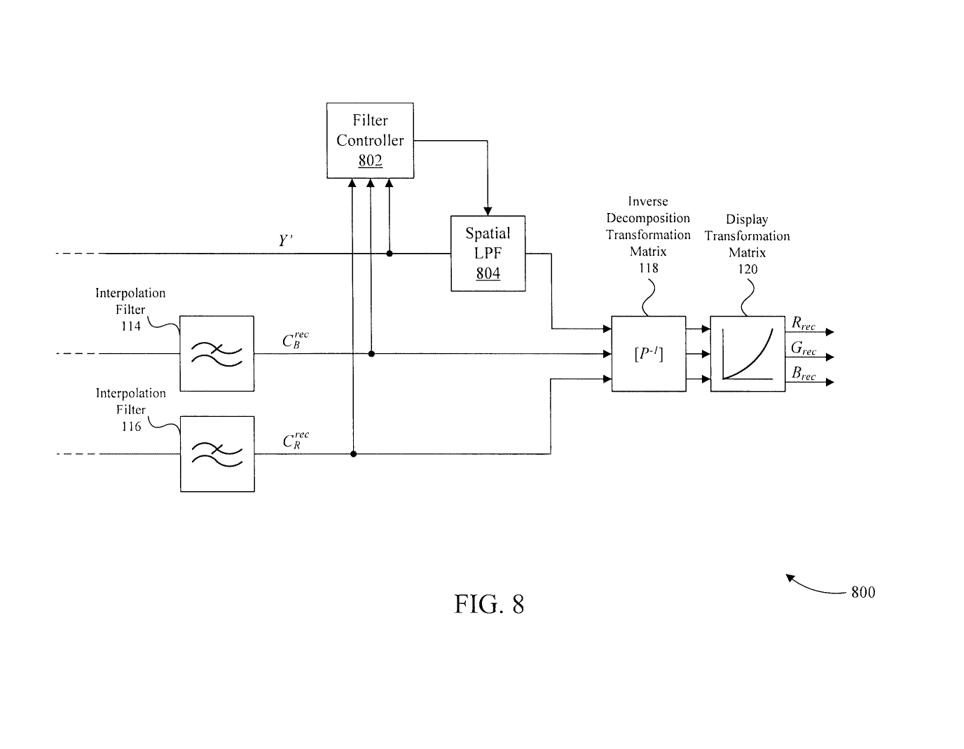

Referring now to FIG. 8, a non-constant luminance video decoder 800 for reducing errors in reproduced luminance of HDR video content (and other types of video content) due to non-constant luminance video encoding is illustrated in accordance with embodiments of the present disclosure. As can be seen, non-constant luminance video decoder 800 has the same exemplary configuration as non-constant luminance video decoder 202 in FIG. 2 with the exception of newly added filter controller 802 and spatial low-pass filter 804.

Filter controller 802 is configured to determine if the color of a non-constant luminance encoded pixel being processed by video decoder 800 falls within a region of a color gamut that may result in a large error in the reproduced luminance of the pixel at video decoder 800 due to non-constant luminance encoding. For example, filter controller 802 can determine if the color of a pixel being processed by video decoder 800 falls within either region 312 or 314 of color gamut 310 in FIG. 3 or within the bottom part of border region 502 of color gamut 500 in FIG. 5. The bottom part of border region 502, between the blue and red vertices, corresponds to a line of purple colors.

As shown in FIG. 8, filter controller 802 can make such a determination based on the Y′, C_{B}^{rec}, and C_{R}^{rec} components of a pixel being processed by video decoder 800. For example, filter controller 802 can perform a video decoding operation (e.g., a standard or normal video decoding operation as described above in regard to FIG. 2) on the Y′, C_{B}^{rec}, and C_{R}^{rec} components of the pixel being processed to obtain R, G, and B color components for the pixel being processed by video decoder 800.

In one embodiment, once R, G, B color components for the pixel being processed by video decoder 800 are obtained, filter controller 802 determines if the color of a pixel being processed by video decoder 800 falls within region 312 or 314 of color gamut 310 in FIG. 3 using threshold values. For example, filter controller 802 can determine the color of the pixel being processed by video decoder 800 falls within region 312 if the green color component G of the pixel is below a first threshold and the blue color component B of the pixel is above a second threshold. Similarly, filter controller 802 can determine the color of the pixel being processed by video decoder 800 falls within region 314 if the green color component G of the pixel is below a first threshold and the red color component R of the pixel is above a second threshold.

In another embodiment, filter controller 802 determines if the color of the pixel being processed by video decoder 800 falls within region 312 if the ratio of the blue color component B of the pixel to the green color component G of the pixel is above a threshold. Similarly, filter controller 802 determines if the color of a pixel being processed by video encoder 800 falls with region 314 if the ratio of the red color component R of the pixel to the green color component G of the pixel is above a threshold.

In yet another embodiment, filter controller 802 determines if the color of the pixel being processed by video decoder 800 falls within the bottom part of border region 502 if the product of the green color component G of the pixel and the perceptual quantized red color component of the pixel PQ(R) is smaller than a given threshold.

Upon determining that the color of the pixel being processed by video decoder 800 falls within region 312, region 314, and/or within the bottom part of border region 502, filter controller 802 can activate spatial low-pass filter 804 to spatially low-pass filter the luma component Y′ of the pixel being processed. Spatial low-pass filter 804 is configured to spatially smooth the luma component Y′ of the pixel being processed by, for example, replacing the luma component Y′ of the pixel with a weighted average of the luma component Y′ of the pixel and the luma components of pixels in a surrounding neighborhood of the pixel being processed. The neighborhood can be formed by a rectangular region of pixels, such as a 4×1 or a 4×2 region of pixels. The weights (or distribution of the weights) used to perform the weighted average by spatial low-pass filter 804 can be adjusted by filter controller 802 to increase or decrease the amount of spatial smoothing of the luma component Y of the pixel being processed. For example, for larger ratios of the blue color component B of the pixel to the green color component G of the pixel, filter controller 802 can adjust the weights used by spatial low-pass filter 804 to increase the amount of spatial smoothing of the luma component Y′ of the pixel.

By spatially smoothing the luma component Y′ of the pixel being processed, the difference in the luma component Y′ of the pixel being processed as compared to the luma components of the pixels in its neighborhood is reduced, which, in turn, should help to reduce the extent of any error of the type described above being produced.

In another embodiment, upon determining that the color of the pixel being processed by video decoder 800 falls within region 312, region 314, and/or within the bottom part of border region 502, filter controller 802 can further check that the spatial variability of the green component G of the pixel being processed is above a threshold before activating spatial low-pass filter 804 as described above. The spatial variability of the green component G of the pixel being processed can be determined, for example, using the following equation:

S.V. of G=max[abs(G_ctr−G_left)/G_ctr, abs(G_ctr−G_right/G_ctr) (16)

where G_ctr is the value of the green component G of the pixel being processed, G_left is the value of the green component of the pixel to the left of the pixel being processed, and G_right is the value of the green component of the pixel to the right of the pixel being processed.

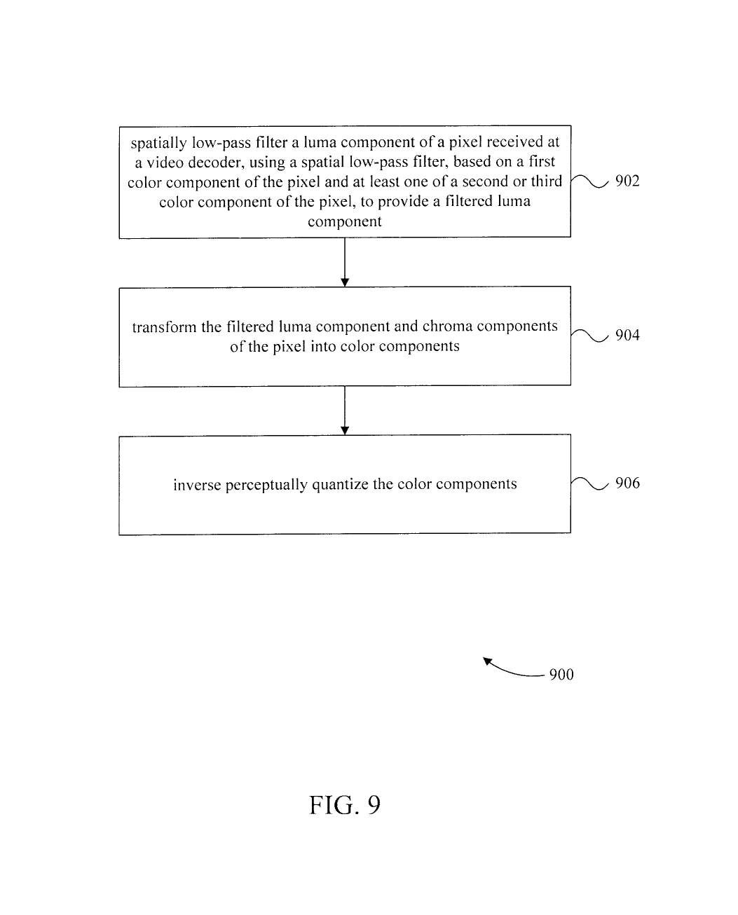

Referring now to FIG. 9, a flowchart 900 of a method for non-constant luminance video decoding of a pixel is illustrated in accordance with embodiments of the present disclosure. The method of flowchart 900 can be performed by video decoder 800 in FIG. 8 or some other video encoder.

The method of flowchart 800 begins at step 802. At step 802, a luma component of a pixel being decoded is spatially low-pass filtered based on a first color component of the pixel and at least one of a second or third color component of the pixel to provide a filtered luma component. For example, the first color component can be a green color component, the second color component can be a red color component, and the third color component can be a blue color component. The luma component can be spatially filtered if the color of the pixel falls within a region of a color gamut that may result in a large error in the reproduced luminance of the pixel at the video decoder due to non-constant luminance encoding. For example, if the color of the pixel being processed by video decoder 800 falls with either region 312 or 314 of color gamut 310 in FIG. 3 and/or within a bottom part of border region 502 of color gamut 500 in FIG. 5, the luma component can be spatially filtered. Threshold values, as described above in regard to FIG. 8 can be used to make such a determination.

After step 902, the method of flowchart 900 proceeds to step 904. At step 904, the filtered luma component and chroma components of the pixel being processed can be transformed into color components. For example, the filtered luma component and the chroma components of the pixel being processed can be transformed into recovered red, green, and blue color components using inverse decomposition transformation matrix 118 in FIG. 8.

After step 904, the method of flowchart 900 proceeds to step 906. At step 906, the recovered red, green, and blue color components can be inverse perceptually quantized. For example, the recovered red, green, and blue color components can be inverse perceptually quantized using display transformation matrix 120 in FIG. 8.

### 5. EXAMPLE COMPUTER SYSTEM ENVIRONMENT

It will be apparent to persons skilled in the relevant art(s) that various elements and features of the present disclosure, as described herein, can be implemented in hardware using analog and/or digital circuits, in software, through the execution of instructions by one or more general purpose or special-purpose processors, or as a combination of hardware and software.

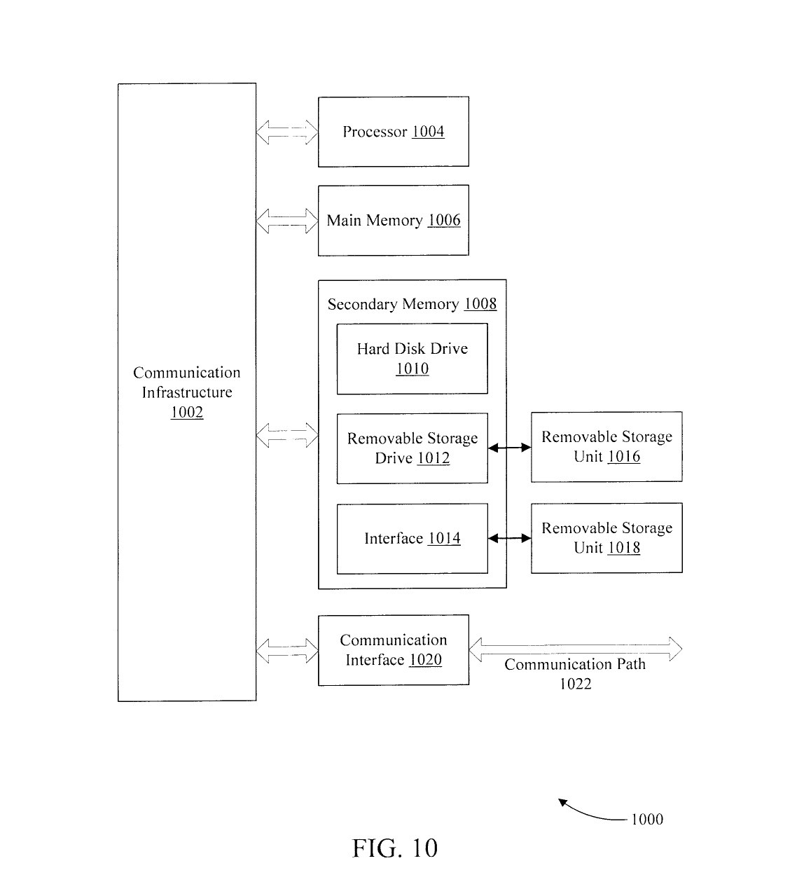

The following description of a general purpose computer system is provided for the sake of completeness. Embodiments of the present disclosure can be implemented in hardware, or as a combination of software and hardware. Consequently, embodiments of the disclosure may be implemented in the environment of a computer system or other processing system. An example of such a computer system 1000 is shown in FIG. 10. Blocks depicted in FIGS. 1, 2, 6, and 8 may execute on one or more computer systems 1000. Furthermore, each of the steps of the method depicted in FIGS. 7 and 9 can be implemented on one or more computer systems 1000.

Computer system 1000 includes one or more processors, such as processor 1004. Processor 1004 can be a special purpose or a general purpose digital signal processor. Processor 1004 is connected to a communication infrastructure 1002 (for example, a bus or network). Various software implementations are described in terms of this exemplary computer system. After reading this description, it will become apparent to a person skilled in the relevant art(s) how to implement the disclosure using other computer systems and/or computer architectures.

Computer system 1000 also includes a main memory 1006, preferably random access memory (RAM), and may also include a secondary memory 1008. Secondary memory 1008 may include, for example, a hard disk drive 1010 and/or a removable storage drive 1012, representing a floppy disk drive, a magnetic tape drive, an optical disk drive, or the like. Removable storage drive 1012 reads from and/or writes to a removable storage unit 1016 in a well-known manner. Removable storage unit 1016 represents a floppy disk, magnetic tape, optical disk, or the like, which is read by and written to by removable storage drive 1012. As will be appreciated by persons skilled in the relevant art(s), removable storage unit 1016 includes a computer usable storage medium having stored therein computer software and/or data.

In alternative implementations, secondary memory 1008 may include other similar means for allowing computer programs or other instructions to be loaded into computer system 1000. Such means may include, for example, a removable storage unit 1018 and an interface 1014. Examples of such means may include a program cartridge and cartridge interface (such as that found in video game devices), a removable memory chip (such as an EPROM, or PROM) and associated socket, a thumb drive and USB port, and other removable storage units 1018 and interfaces 1014 which allow software and data to be transferred from removable storage unit 1018 to computer system 1000.

Computer system 1000 may also include a communications interface 1020. Communications interface 1020 allows software and data to be transferred between computer system 1000 and external devices. Examples of communications interface 1020 may include a modem, a network interface (such as an Ethernet card), a communications port, a PCMCIA slot and card, etc. Software and data transferred via communications interface 1020 are in the form of signals which may be electronic, electromagnetic, optical, or other signals capable of being received by communications interface 1020. These signals are provided to communications interface 1020 via a communications path 1022. Communications path 1022 carries signals and may be implemented using wire or cable, fiber optics, a phone line, a cellular phone link, an RF link and other communications channels.

As used herein, the terms “computer program medium” and “computer readable medium” are used to generally refer to tangible storage media such as removable storage units 1016 and 1018 or a hard disk installed in hard disk drive 1010. These computer program products are means for providing software to computer system 1000.

Computer programs (also called computer control logic) are stored in main memory 1006 and/or secondary memory 1008. Computer programs may also be received via communications interface 1020. Such computer programs, when executed, enable the computer system 1000 to implement the present disclosure as discussed herein. In particular, the computer programs, when executed, enable processor 1004 to implement the processes of the present disclosure, such as any of the methods described herein. Accordingly, such computer programs represent controllers of the computer system 1000. Where the disclosure is implemented using software, the software may be stored in a computer program product and loaded into computer system 1000 using removable storage drive 1012, interface 1014, or communications interface 1020.

In another embodiment, features of the disclosure are implemented primarily in hardware using, for example, hardware components such as application-specific integrated circuits (ASICs) and gate arrays. Implementation of a hardware state machine so as to perform the functions described herein will also be apparent to persons skilled in the relevant art(s).

### 6. CONCLUSION

Embodiments have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

What is claimed is:

1. An encoder, comprising:
a spatial low-pass filter;
a filter controller configured to control the spatial low-pass filter to provide more spatial smoothing to a green component of a first pixel than to a green component of a second pixel based on a color of the first pixel being closer to a red or blue vertex of a color gamut than a color of the first pixel;
a perceptual transfer function configured to perceptually quantize the green component of the first pixel after the green component has been spatially low-pass filtered by the spatial low-pass filter to provide a perceptually quantized first color component;
a decomposition transformation matrix configured to transform the perceptually quantized green color component, a perceptually quantized red color component, and a perceptually quantized blue color component into a luma component and chroma components; and
a subsampling filter configured to subsample the chroma components.

2. The encoder of claim 1, wherein the filter controller is configured to control the spatial low-pass filter to provide no spatial smoothing to the green component of the second pixel based on the green component of the second pixel being above a first threshold or based on a red or blue component of the second pixel being below a second threshold.

3. The encoder of claim 1, wherein the filter controller is configured to control the spatial low-pass filter to provide at least some spatial smoothing to the green component of the second pixel based on the green component of the second pixel being below a first threshold and a red or blue component of the second pixel being above a second threshold.

4. The encoder of claim 1, wherein the filter controller is configured to control the spatial low-pass filter to provide at least some spatial smoothing to the green component of the first pixel based on the green component of first pixel being below a first threshold and a red or blue component of the first pixel being above a second threshold.

5. The encoder of claim 1, wherein the color of the first pixel is defined by the green component of the first pixel, a red component of the first pixel, and a blue component of the first pixel.

6. The encoder of claim 1, wherein the filter controller is configured to control an amount of spatial smoothing provided by the spatial low-pass filter to the green component of the first pixel by adjusting a distribution of weights used by the spatial low-pass filter to weight the green component of the first pixel and the green components of pixels in a surrounding neighborhood of the first pixel.

7. An encoder, comprising:
a spatial low-pass filter configured to spatially smooth a first color component of a pixel to provide a filtered first color component;
a filter controller configured to control the spatial low-pass filter based on the first color component of the pixel and at least one of a second or third color component of the pixel;
a perceptual transfer function configured to perceptually quantize the filtered first color component to provide a perceptually quantized first color component;
a decomposition transformation matrix configured to transform the perceptually quantized first color component, a perceptually quantized second color component, and a perceptually quantized third color component into a luma component and chroma components; and
a subsampling filter configured to subsample the chroma components.

8. The encoder of claim 7, wherein the first color component of the pixel is green.

9. The encoder of claim 7, wherein the filter controller is configured to enable and disable the spatial low-pass filter based on a position, in a color gamut, of a point that corresponds to the first color component of the pixel, the second color component of the pixel, and the third color component of the pixel.

10. The encoder of claim 7, wherein the filter controller is configured to adjust an amount of smoothing provided by the spatial low-pass filter based on a position, in a color gamut, of a point that corresponds to the first color component of the pixel, the second color component of the pixel, and the third color component of the pixel.

11. The encoder of claim 7, wherein the filter controller is configured to enable the spatial low-pass filter based on the first color component of the pixel, the second color component of the pixel, and the third color component of the pixel corresponding to a point within a border region of a color gamut.

12. The encoder of claim 7, wherein the filter controller is configured to enable the spatial low-pass filter based on the first color component of the pixel being below a first threshold and the second color component of the pixel being above a second threshold.

13. The encoder of claim 7, further comprising:
an additional pair of spatial low-pass filters configured to spatially low-pass filter the second color component of the pixel before the second color component of the pixel is perceptually quantized and spatially low-pass filter the third color component of the pixel before the third color component of the pixel is perceptually quantized.

14. The encoder of claim 12, wherein the filter controller is further configured to control the additional pair of spatial low-pass filters.

15. A method for encoding, comprising:
spatially low-pass filtering a first color component of a pixel, using a spatial low-pass filter, based on the first color component of the pixel and at least one of a second or third color component of the pixel to provide a filtered first color component;
perceptually quantizing the filtered first color component to provide a perceptually quantized first color component;
transform the perceptually quantized first color component, a perceptually quantized second color component, and a perceptually quantized third color component into a luma component and chroma components; and
subsampling the chroma components.

16. The method of claim 15, wherein the first color component of the pixel is green.

17. The method of claim 15, wherein spatially low-pass filtering the first color component of the pixel further comprises:
enabling and disabling the spatial low-pass filter based on a position, in a color gamut, of a point that corresponds to the first color component of the pixel, the second color component of the pixel, and the third color component of the pixel.

18. The method of claim 15, wherein spatially low-pass filtering the first color component of the pixel further comprises:
adjusting an amount of smoothing provided by the spatial low-pass filter based on a position, in a color gamut, of a point that corresponds to the first color component of the pixel, the second color component of the pixel, and the third color component of the pixel.

19. The method of claim 15, wherein spatially low-pass filtering the first color component of the pixel further comprises:
enabling the spatial low-pass filter based on the first color component of the pixel, the second color component of the pixel, and the third color component of the pixel corresponding to a point within a border region of a color gamut.

20. The method of claim 15, wherein spatially low-pass filtering the first color component of the pixel further comprises:
enabling the spatial low-pass filter based on the first color component of the pixel being below a first threshold and the second color component of the pixel being above a second threshold.

21. A decoder, comprising:
a spatial low-pass filter configured to spatially smooth a luma component of a pixel to provide a filtered luma component;
a filter controller configured to enable and disable the spatial low-pass filter based on a position, in a color gamut, of a point that corresponds to a first color component of the pixel, a second color component of the pixel, and a third color component of the pixel,
an inverse decomposition transformation matrix configured to transform the filtered luma component and chroma components into color components; and
an inverse perceptual transfer function configured to inverse perceptually quantize the color components.
